(19) United States
(12) Patent Application Publication
(10) Pub. No.: US 2024/0034374 A1
(43) Pub. Date: Feb. 1, 2024

(54) Method for Operating a Rail Vehicle and Arrangement Comprising a Rail Vehicle

(71) Applicant: Bombardier Transportation GmbH, Berlin (DE)

(72) Inventor: Andrea Mazzone, Zürich (CH)

(21) Appl. No.: 18/039,752

(22) PCT Filed: Dec. 2, 2021
(86) PCT No.: PCT/EP2021/083892

§ 371 Date: Jun. 1, 2023

(30) Foreign Application Priority Data
Dec. 2, 2020 (DE) 102020215245.4

(51) Int. Cl. B61L 27/04; B61L 23/04; B61L 27/57; B64U 80/30; B64U 80/86

(52) U.S. Cl. CPC B61L 27/04; B61L 23/041; B61L 27/57; B64U 80/30; B64U 80/86

(57) ABSTRACT

The invention relates to a method and an arrangement for operating a rail vehicle (1), wherein, before travel of the rail vehicle (1) is started, an environment of the rail vehicle (1) is captured by at least one sensor (17) on board a flying unmanned aerial vehicle (3) and corresponding sensor signals are generated, and wherein the rail vehicle (1) is released or not released for travel depending on a result of an evaluation of the sensor signals.

The invention relates to a method for operating a rail vehicle and an arrangement comprising a rail vehicle.

Regulations exist for preparing for travel of a rail vehicle, according to which personnel must inspect the environment of the rail vehicle to determine whether persons, animals or non-living objects will obstruct the movement of the rail vehicle. However, before travel is started, it is also necessary to check whether there are any other conditions of the rail vehicle perceivable from the outside that will hinder or prevent proper travel, such as loose parts or disconnected cables. In particular, it is often also required that the environment of the rail vehicle below the rail vehicle, i.e. between the rail vehicle and the track on which the rail vehicle is standing, be inspected.

Visual inspection of the environment by eye takes time and may be prone to error depending on lighting conditions. It is also possible that, during the phase of checking the environment, a person, animal or object moves or is moved into a part of the environment that has already been checked and then presents an obstacle. The time required for the capturing of the environment is particularly long if the rail vehicle is a train.

It is possible to equip the rail vehicle with cameras or other sensors to automatically detect obstacles in the environment of the rail vehicle. However, to capture the entire environment in this way, a large number of cameras are needed.

It is an object of the present invention to facilitate the preparation for travel for the personnel of a rail vehicle.

It is proposed to use an unmanned aerial vehicle for capturing the environment of the rail vehicle, which captures the environment of the rail vehicle by means of at least one sensor on board the aerial vehicle during a flight of the aerial vehicle. Depending on an evaluation of the sensor signals generated in this way, the rail vehicle is released or not released for travel.

The use of at least one unmanned aerial vehicle, often also referred to as a drone, has the advantage that the personnel of the rail vehicle are relieved of the task of preparing for the travel and do not have to take a look at the entire environment of the rail vehicle.

Preferably, the at least one sensor of the aerial vehicle captures the entire environment of the rail vehicle, including the space between the rail vehicle and a track on which the rail vehicle is standing. An aerial vehicle that is part of an arrangement comprising the rail vehicle may be configured accordingly. In particular, the aerial vehicle may therefore fly between the rail vehicle and the track, sensing the environment and in particular the space between the rail vehicle and the track by means of the at least one sensor or by means of at least one of a plurality of sensors on board the aerial vehicle. In particular, the aerial vehicle may fly through the space between the rail vehicle and the track. Alternatively or additionally, it is possible that the aerial vehicle does not fly into the space between the rail vehicle and the track, but captures this space using the at least one sensor or part of the sensors. This space in particular is difficult for personnel to capture. This is due to the low position of the space and often also to the lighting conditions.

As mentioned above, there may be at least one sensor on board the unmanned aerial vehicle for capturing the environment of the rail vehicle. This therefore includes the case where there is more than one sensor on board the aerial vehicle for capturing. The sensor or at least one of the sensors may be a digital camera, for example a camera that repeatedly generates images of the environment of the rail vehicle. The sensor or at least one of the sensors may be a video camera, wherein, in the case of a sensor that is not formed as a video camera, meaningful information about the environment of the rail vehicle is also obtained when a plurality of individual images are captured. The recording of individual images has the advantage that the effort for evaluating the images is less than with a video camera that records the environment of the rail vehicle over a longer period of time.

However, other types of sensors besides a digital camera may be used to capture the environment, for example ultrasonic sensors, radar sensors, laser scanners and similar sensors such as LiDar sensors. However, the invention is not limited to the types of sensors mentioned. In principle, any type of sensor that enables the environment of the rail vehicle to be captured is suitable.

In particular, a method is proposed for operating a rail vehicle, wherein
before travel of the rail vehicle is started, an environment of the rail vehicle is captured by at least one sensor on board a flying unmanned aerial vehicle and corresponding sensor signals are generated,
depending on a result of an evaluation of the sensor signals, the rail vehicle is released or not released for travel.

An arrangement is further proposed comprising a rail vehicle, wherein the arrangement further comprises an unmanned aerial vehicle, wherein
the unmanned aerial vehicle is configured to capture an environment of the rail vehicle by at least one sensor on board the flying unmanned aerial vehicle before travel of the rail vehicle is started and to generate corresponding sensor signals,
a control system of the rail vehicle is configured to start or not to start the travel of the rail vehicle depending on a result of an evaluation of the sensor signals.

In particular, a release signal may be generated, wherein this signal either signals that the rail vehicle is released for travel or signals that the rail vehicle is not released for travel (negative release signal). Depending on the embodiment of the method or the arrangement, the release signal may have a single one of these two meanings or, in another embodiment, it may also have both meanings in different operating modes. In particular, it is therefore possible in a specific embodiment that travel may only start after receipt of the release signal, for example by a control system of the rail vehicle. In another embodiment, travel may start if no negative release signal is received within a predefined period of time.

The environment of the rail vehicle is generally not sharply defined. The capturing of the environment depends on the respective regulations for the operation and preparation for travel of the rail vehicle. However, the regulations may stipulate, for example, that the track in the direction of travel in front of the rail vehicle must be checked for obstacles up to a minimum distance. In the case of an electrical network line, such as an overhead line or conductor rail, through which the rail vehicle draws electrical energy for operation from a supply network, the condition of the network line must usually also be checked, such as the presence of the overhead line.

Contact with the network line by the unmanned aerial vehicle is usually to be avoided, for example by sensor technology integrated into the aerial vehicle and motion control system of the aerial vehicle, which ensure the permanent distance to any persons, animals and objects. Therefore, the aerial vehicle preferably has sensor technology already known for unmanned aerial vehicles, in particular in addition to the at least one sensor for capturing the environment of the rail vehicle. This sensor system may, for example, comprise at least one infrared sensor and/or at least one ultrasonic sensor directed forwards in the direction of flight. Infrared sensors are well suited for avoiding a collision and thus maintaining a minimum distance, because they may also capture objects that otherwise appear diffuse in a camera image, for example. Alternatively or additionally, the sensor system may have a sound sensor, for example an ultrasonic sensor, which functions according to the echo principle. Therefore, at least in the direction of flight, a collision may be avoided by receiving sound waves reflected from persons, animals or objects. Alternatively or additionally, the aerial vehicle may have at least one LiDar (Light Detection and Ranging) sensor. When using this technology, the space around the aerial vehicle is measured with the help of electromagnetic radiation, in particular laser radiation. Here, the direction of the radiation is continuously changed and in particular varied in the manner of a rotation, for example corresponding to a rotation with several hundred revolutions per minute. Meanwhile, at least one LiDar reception sensor of the aerial vehicle receives any reflected radiation. By evaluating the reflected radiation, a highly accurate map of all reflective surfaces in the surrounding space is created and is used by the aerial vehicle's motion control system for navigation.

When detecting obstacles and loose parts around the rail vehicle, the aforementioned additional sensor technology is of particular interest, as an obstacle may unexpectedly lie on a possibly pre-planned flight path of the aerial vehicle around the rail vehicle and/or in the vicinity of the rail vehicle, for example under the rail vehicle on the track bed. In this respect, the aforementioned sensor technology or exclusively this sensor technology may also be used to detect persons, animals and objects in the vicinity of the rail vehicle.

The unmanned aerial vehicle is preferably an autonomous aerial vehicle that controls its own flight operation. In principle, however, it is also possible that the flight operation of the aerial vehicle is controlled remotely. In any case, the unmanned aerial vehicle may have a propulsion system that enables its locomotion. In the case of drones, for example, arrangements with several propellers are known, each of which is driven by its own associated electric motor, for example, and is controlled by means of a controller in such a way that the desired locomotion or the desired standstill in the air is achieved.

Furthermore, it is within the scope of the invention not to use only one unmanned aerial vehicle for the capturing of the environment of the rail vehicle and the generation of the sensor signals, depending on the evaluation of which the rail vehicle is released or not for travel. For example, two or more unmanned aerial vehicles may be used simultaneously and/or successively for this purpose.

In particular, the unmanned aerial vehicle may be initially coupled to the rail vehicle, the unmanned aerial vehicle may be uncoupled from the rail vehicle, and the at least one sensor may capture the environment of the rail vehicle after the uncoupling. In a corresponding embodiment of the arrangement according to the invention, the rail vehicle comprises a coupling device for coupling the unmanned aerial vehicle to the rail vehicle, wherein the rail vehicle and the unmanned aerial vehicle are configured to uncouple the unmanned aerial vehicle from the rail vehicle, and wherein the unmanned aerial vehicle is configured to capture the environment of the rail vehicle by the at least one sensor after the uncoupling.

Coupling of the aerial vehicle and of the rail vehicle or coupling of the aerial vehicle to the rail vehicle is understood to mean that the aerial vehicle is connected to and/or in contact with the rail vehicle in at least one arbitrary way. For example, the connection and/or contact may be mechanical and/or electrical. For example, a connection by magnetic forces is also possible. In order to protect the aerial vehicle coupled to the rail vehicle, in particular during travel of the rail vehicle, at least one cover may be provided to separate the aerial vehicle from the environment of the rail vehicle. A corresponding space with such a cover may be referred to as a garage. Preferably, the space with cover is located on the roof of the rail vehicle, since there is usually sufficient space there and there are usually other devices provided on the roof that serve for the operation of the rail vehicle and do not lead to an exceedance of the permissible dimensions. For example, the space with cover for the aerial vehicle may be in the slipstream of another device located at or on the roof when the rail vehicle is travelling.

In other embodiments, the aerial vehicle is not stationed in and/or on the rail vehicle as previously described, but in and/or on another rail vehicle or a fixed facility such as a locomotive shed. The advantage of stationing in and/or on the rail vehicle is that the availability of the aerial vehicle for the examination of the rail vehicle is increased. By contrast, stationing the aerial vehicle independently of a particular rail vehicle allows the aerial vehicle to be used to prepare for the travel of different rail vehicles.

The uncoupling of the aerial vehicle in the case of stationing on the rail vehicle but also in other cases means the release of the connection and/or the cancellation of the contact. For example, an electrical connection via which the aerial vehicle is supplied or may be supplied with electrical energy during the electrical contact is cancelled and a magnetic connection or a mechanical connection (such as a clamp connection) is released. The electrical energy is used during the contact, in particular for charging an energy storage device on board the aerial vehicle. In particular, it is also possible for the aerial vehicle to release the connection on its own, for example by switching off a magnetic device or by the aerial vehicle starting a drive that results in the aerial vehicle moving forward.

In particular, an evaluation device on board the unmanned aerial vehicle may evaluate the sensor signals and, depending on the result of the evaluation, a release signal may be generated, which is transmitted to the rail vehicle and releases the rail vehicle for travel. In a corresponding embodiment of the arrangement, the unmanned aerial vehicle has an evaluation device which is configured to evaluate the sensor signals and to generate a release signal depending on the result of the evaluation, wherein the arrangement has transmission devices which are configured to transmit the release signal to the rail vehicle, and wherein the control system of the rail vehicle is configured to release the rail vehicle for travel after receipt of the release signal or in the absence of the release signal.

The transmission devices have, in particular, an emitting device on board the aerial vehicle and a receiving device on board the rail vehicle, which enable wireless transmission. For example, known transmission protocols are used in the transmission itself, such as in a WLAN (Wireless Local Area Network). More generally formulated, a technology using electromagnetic waves may be used for the transmission of the release signal or alternatively or additionally for the transmission of at least part of the sensor signals and/or by processing data obtained therefrom. Alternatively or additionally, sound waves may be used, for example.

The advantage of evaluating the sensor signals on board the aerial vehicle is that the rail vehicle itself does not have to have the corresponding technology and therefore existing rail vehicles may be converted in a simple manner. It is only necessary to set up the control system of the rail vehicle in such a way that travel is only started after receipt of the release signal or in the absence of the release signal. In most cases, existing rail vehicles already have suitable receiving devices.

Alternatively or in addition to the evaluation of the sensor signals on board the aerial vehicle, the evaluation may take place at least partially on board the rail vehicle or on board another aerial vehicle. In particular, it is therefore also possible that the evaluation of the sensor signals with regard to the question of whether travel may be started takes place entirely on board the rail vehicle. This does not exclude that a pre-processing of the sensor signals takes place on board the aerial vehicle, such as a conversion into a specific image data format, a fusion of the sensor signals of different sensors, a plausibility check of the information contained in the sensor signals and/or a filtering of the information contained in the sensor signals or information derived therefrom.

Thus, the method may also be configured in such a way that a control system of the rail vehicle receives the sensor signals and/or sensor data generated by processing the sensor signals, wherein the control system evaluates the received sensor signals and/or the sensor data and, depending on the result of the evaluation, generates a release signal which releases or prohibits travel of the rail vehicle. According to a corresponding embodiment of the arrangement, the control system of the rail vehicle has a receiving device for receiving the sensor signals and/or sensor data generated by processing the sensor signals, wherein the control system also has an evaluation device which is configured to evaluate the received sensor signals and/or the sensor data and, depending on the result of the evaluation, to generate a release signal which releases or prohibits travel of the rail vehicle.

In particular, it is possible that the flight of the unmanned aerial vehicle is automatically triggered by a control system of the rail vehicle (for example, the aforementioned control system) when preparation is being made for the travel of the rail vehicle. For example, the flight may be triggered when the rail vehicle is being made ready, wherein, for example, a pantograph of the rail vehicle is also brought into contact with an overhead line.

When evaluating the sensor signals, for example, comparison information about a target state of the environment of the rail vehicle and/or the external appearance of the rail vehicle may be used. For example, in the case of image data generated from the sensor signals, each corresponding to an image of a part of the environment of the rail vehicle, a comparison may take place with data of a comparison image on which no obstacle and/or no loose parts is/are depicted. In particular, by identifying common elements in the image and the comparison image, or by the known method of maximising the common information while changing the position and/or orientation of one of the images relative to the other image, the reference of the coordinate systems of the images may be established. Then, for example, by identifying the information not contained in both images or the elements not contained in both images, an obstacle and/or loose or defective part may be captured.

Alternatively or additionally, the sensor signals may be evaluated in another way. In particular, it may be possible to look for defined objects and/or persons. For example, objects and/or persons are predefined, such as by corresponding image data and/or three-dimensional models.

In particular, objects and/or persons that are identified as not belonging to the vehicle may be classified. Artificial intelligence methods, in particular trained using machine learning processes, may be applied here. After the classification, a decision may be made as to whether or not the rail vehicle is released for travel.

In particular, travel of the rail vehicle may be automatically permitted by the control system of the rail vehicle as soon as the release signal has been generated internally by the control system and/or has been received externally (e.g. from the aerial vehicle) or if the negative release signal has failed to appear. The permission leads, for example, automatically to the drive system of the rail vehicle being put into readiness for travel and/or to the driver of the rail vehicle being informed that the vehicle is ready to drive. Preferably, images generated from the sensor signals of the at least one aerial vehicle are not displayed to the driver of the rail vehicle, since the procedure for evaluating such images is preferably performed automatically. However, it is not excluded to display the images to the vehicle driver. For example, in this case, the driver of the vehicle may obtain further information from the images and recognise that the procedure is being carried out. In particular, the display of at least one image is advantageous when an obstacle or a loose or defective part has been captured. This makes it easier to remove the obstacle or to remove or fix the loose part or to repair the defect.

Exemplary embodiments of the invention are now described with reference to the accompanying drawing. In the individual figures of the drawing:

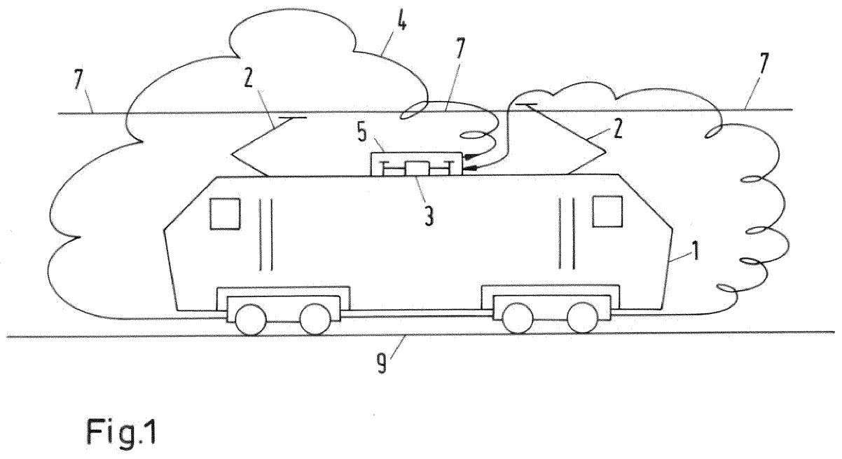

FIG. 1 schematically shows a rail vehicle, in this case a locomotive, with an unmanned aerial vehicle stationed on the roof of the rail vehicle and a possible flight path of the aerial vehicle around the rail vehicle,

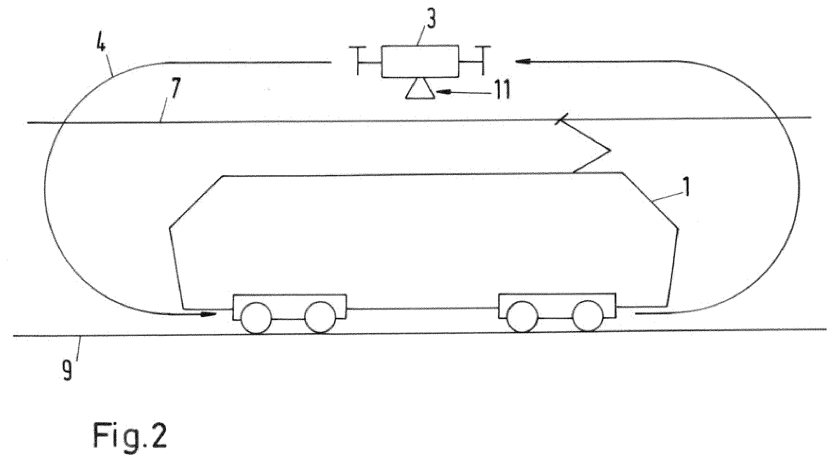

FIG. 2 schematically shows the rail vehicle from FIG. 1, wherein the aerial vehicle is located above the rail vehicle during its flight,

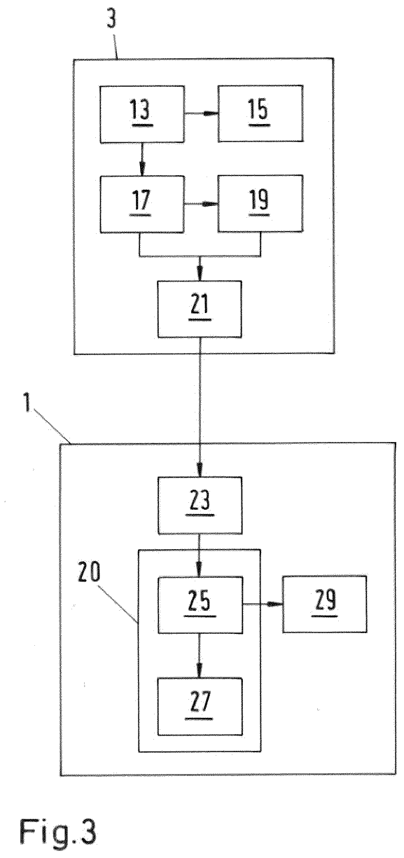

FIG. 3 shows a block diagram of an arrangement of devices for preparing for travel of a rail vehicle, for example the rail vehicle shown in FIG. 1 and FIG. 2.

FIG. 1 shows a rail vehicle 1, which is schematically shown as a locomotive. Alternatively, however, it may be another rail vehicle such as a trainset, a traction unit, a tram, a goods train, a passenger train or coupled locomotives. In the embodiment example, the rail vehicle 1 has pantographs 2 that contact an overhead line 7 during travel of the rail vehicle 1 in order to supply the rail vehicle 1 with electrical energy. The rail vehicle stands on a track 9, for example on the premises of a depot of a rail vehicle operator.

On the roof of the rail vehicle is a garage 5 for an unmanned aerial vehicle 3, which is located inside the garage 5 in the state shown. The garage 5 is at the same time a charging station for charging an energy storage device of the unmanned aerial vehicle 3. When travel of the rail vehicle 1 is to be started, a flight of the unmanned aerial vehicle 3 takes place to check the environment of the rail vehicle 1 for the presence of obstacles and/or loose or defective parts. For this purpose, a flap of the garage 5 is opened, for example a lid and/or a side wall, so that the aerial vehicle 3 may fly upwards and/or sideways out of the garage 5 and then may fly away, in particular sideways, without contacting the overhead line 7. The flight of the aerial vehicle 3 is triggered, for example, by a control system of the rail vehicle 1 by transmitting a corresponding communication signal to the aerial vehicle 3 and to a controller of the garage 5 for the purpose of opening the flap.

For example, the aerial vehicle 3 then performs a flight on the schematically depicted flight path 4 while at least one sensor of the aerial vehicle 3 captures the environment of the rail vehicle 1 in order to simultaneously and/or subsequently detect obstacles and/or loose or defective parts of the rail vehicle by evaluating the sensor signals. After execution of the flight, the aerial vehicle 3 returns to the garage 5 and the flap of the garage is closed. The evaluation of the sensor signals may include pre-processing of the sensor signals, such as generating image data and/or fusing multiple images. In the exemplary embodiment, the flight path 4 also passes under the rail vehicle 1 so that obstacles and/or loose or defective parts may also be detected under the rail vehicle 1 in the direction of travel and directly in front of the rail vehicle 1.

FIG. 2 shows the arrangement from FIG. 1 with a special configuration of the aerial vehicle 3, in which the aerial vehicle 3 has a downward-facing camera 11. Image data are generated and recorded by means of the sensor signals of this camera 11. In this case, the sensor signals therefore signal amounts of radiation received by the individual sensor elements (for example, photodiodes) of the camera, which is configured as a digital camera, over a capturing time interval.

The camera 11 shown in FIG. 2 may optionally be configured to be movable relative to the aerial vehicle 3, for example, to be pivotable. In this way, the camera 11 may capture different parts of the environment of the rail vehicle 1 and record corresponding image information without requiring a relative movement of the aerial vehicle 3 and the rail vehicle 1, or the flight path of the aerial vehicle 3 may be shorter.

The schematic block diagram in FIG. 3 shows devices of an unmanned aerial vehicle, for example the aerial vehicle 3 shown in FIG. 1 and FIG. 2, and devices of a rail vehicle, for example the rail vehicle 1 shown in FIG. 1 and FIG. 2. The aerial vehicle 3 has a controller 13 which is configured to transmit control signals to a drive 15 and to a sensor 17 and in this way to control their operation. The sensor 17 is configured to transmit data corresponding to the sensor signals it generates, in whole or in part, to a data memory 19 where the data are stored.

Furthermore, the aerial vehicle 3 has an emitting device 21 by means of which sensor signals of the sensor 17 and/or data stored in the data memory 19 may be transmitted, in particular wirelessly, to a receiving device 23 of the rail vehicle 1. However, it is also possible for data transmission to take place in a line-conducted manner as soon as the aerial vehicle 3 has been coupled to a transmission line after its flight. The received sensor signals and/or data may be transmitted from the receiving device 23 to an evaluation device 25 of a control system 20 of the rail vehicle 1. The evaluation device 25 is connected via corresponding signal lines to a drive controller 27 of the control system 20 and to a display device 29 of the rail vehicle 1, for example in the driver's cab of the rail vehicle 1.

Before travel of the rail vehicle 1, in particular immediately after and/or during the making ready of the rail vehicle 1, the aerial vehicle 3 may fly on a flight path, for example as described with reference to FIG. 1, and the sensor 17 and optionally at least one further sensor of the aerial vehicle 3 may capture the environment of the rail vehicle 1. In preparation for the flight and during the flight, the drive 15 of the aerial vehicle 3 is controlled by the controller 13 of the aerial vehicle 3 such that the flight is performed. In addition, the controller 13 controls the sensor 17 and optionally the at least one further sensor in such a way that the environment of the rail vehicle 1 is captured.

For example, after an operation start triggered by the controller 13, the sensor 17 embodied as a camera may record individual camera images at regular time intervals and store them in the data memory 19 until the controller 13 terminates the operation of the sensor 17 again. In another embodiment of the aerial vehicle 3 or in another operating phase, the controller 13 may control the sensor 17 in such a way that, after receiving a control signal, a single camera image is recorded and stored in the data memory 19. This enables the controller 13 to generate camera images selectively, for example at predefined points of a predefined flight path and/or depending on the evaluation of previously generated sensor signals. Alternatively or additionally, the orientation of the sensor 17 may be adjustable and the aerial vehicle 3 may therefore have an actuator controllable by the controller 13 to effect the desired orientation of the sensor 17.

In the embodiment of the arrangement shown in FIG. 3, the evaluation of the sensor signals and/or data generated therefrom does not take place in the aerial vehicle 3. In another embodiment, however, this may be the case in whole or in part.

According to the embodiment of FIG. 3, the signals and/or data transmitted via the emitting device 21 of the aerial vehicle 3 to the receiving device 23 of the rail vehicle 1 are evaluated by the evaluation device 25 of the control system 20 of the rail vehicle 1. The evaluation determines whether there are obstacles and/or loose or defective parts in the environment of the rail vehicle 1, including the space under the rail vehicle 1. If this is the case, the travel of the rail vehicle 1 is blocked and/or not released by outputting a signal from the evaluation device 25 to the drive controller 27 of the rail vehicle 1. In addition, it is displayed in particular to the vehicle driver that the determined reason for the persistent standstill of the vehicle is present. For example, the display device 29 may comprise at least one signal light and/or at least one screen. In the case of the signal light, for example, the illumination may indicate the determined reason. Alternatively or additionally, an image containing a determined obstacle and/or loose or defective part may be displayed on the screen, wherein the image has been generated from the sensor signals of the sensor 17 and/or optionally from sensor signals of the at least one further sensor.

### LIST OF REFERENCE SIGNS

1 rail vehicle
2 pantograph
3 unmanned aerial vehicle
4 flight path
5 garage
7 overhead line
9 track
11 camera
13 controller
15 drive
17 sensor
19 data memory
20 control system
21 emitting device
23 receiving device
25 evaluation device
27 drive controller
29 display device

1-10. (canceled)

11. A method for operating a rail vehicle, wherein:
before travel of the rail vehicle is started, an environment of the rail vehicle is captured by at least one sensor on board a flying unmanned aerial vehicle and corresponding sensor signals are generated,
depending on a result of an evaluation of the sensor signals, travel of the rail vehicle is released or not released,
the unmanned aerial vehicle flies between the rail vehicle and a track on which the rail vehicle is standing while the at least one sensor captures the environment of the rail vehicle.

12. The method according to claim 11, wherein the unmanned aerial vehicle is initially coupled to the rail vehicle, the unmanned aerial vehicle is uncoupled from the rail vehicle, and the at least one sensor captures the environment of the rail vehicle after the uncoupling.

13. The method according to claim 11, wherein an evaluation device on board the unmanned aerial vehicle evaluates the sensor signals and, depending on the result of the evaluation, generates a release signal, which is transmitted to the rail vehicle and releases the travel of rail vehicle.

14. The method according to claim 11, wherein a control system of the rail vehicle receives the sensor signals and/or sensor data generated by processing the sensor signals, and wherein the control system evaluates the received sensor signals and/or the sensor data and, depending on the result of the evaluation, generates a release signal which releases or prohibits travel of the rail vehicle.

15. An arrangement comprising a rail vehicle, wherein the arrangement further comprises an unmanned aerial vehicle, wherein:
the unmanned aerial vehicle is configured to capture an environment of the rail vehicle by at least one sensor on board the flying unmanned aerial vehicle before the start of a travel of the rail vehicle and to generate corresponding sensor signals,
a control system of the rail vehicle is configured to start or not to start the travel of the rail vehicle depending on a result of an evaluation of the sensor signals,
the unmanned aerial vehicle is configured to fly between the rail vehicle and a track on which the rail vehicle is standing while the at least one sensor captures the environment of the rail vehicle.

16. The arrangement according to claim 15, wherein the rail vehicle comprises a coupling device for coupling the unmanned aerial vehicle to the rail vehicle, wherein the rail vehicle and the unmanned aerial vehicle are configured to uncouple the unmanned aerial vehicle from the rail vehicle, and wherein the unmanned aerial vehicle is configured to capture the environment of the rail vehicle by the at least one sensor after the uncoupling.

17. The arrangement according to claim 15, wherein the unmanned aerial vehicle has an evaluation device which is configured to evaluate the sensor signals and, depending on the result of the evaluation, to generate a release signal, wherein the arrangement has transmission devices which are configured to transmit the release signal to the rail vehicle, and wherein the control system of the rail vehicle is configured to release the travel of the rail vehicle after receipt of the release signal or in the absence of the release signal.

18. The arrangement according to claim 15, wherein the control system of the rail vehicle has a receiving device for receiving the sensor signals and/or sensor data generated by processing the sensor signals, and wherein the control system also has an evaluation device which is configured to evaluate the received sensor signals and/or the sensor data and, depending on the result of the evaluation, to generate a release signal which releases or prohibits the travel of the rail vehicle.
